(19) United States
(12) Patent Application Publication
(10) Pub. No.: US 2011/0292936 A1
(43) Pub. Date: Dec. 1, 2011

(54) Method and System for Transmitting Multichannel Data Packets

(76) Inventors: Weiqiang Wang, Guangdong Province (CN); Jianshi Liang, Guangdong Province (CN); Ping Fan, Guangdong Province (CN)

(21) Appl. No.: 13/140,101

(22) PCT Filed: Aug. 28, 2009
(86) PCT No.: PCT/CN2009/073606

§ 371 Date: Jul. 21, 2011

(30) Foreign Application Priority Data
Dec. 17, 2008 (CN) 2008101861040

(51) Int. Cl. H04L 12/56; H04L 12/28

(52) U.S. Cl. 370/389

(57) ABSTRACT

A method and a system for transmitting multichannel data packets are disclosed in the present invention to implement the transmission of the multichannel data packets with the same network socket, and to improve the work efficiency of the multichannel data packet transmission. The method for transmitting multichannel data packets provided in the present invention comprises: creating a network socket which includes a routing cache array for caching the routing information of the multichannel data packets; acquiring the routing information of the multichannel data packets and adding the routing information to the routing cache array; acquiring the routing information of the multichannel data packets from the routing cache array when the multichannel data packets need to be transmitted and sending out the multichannel data packets according to the routing information.

### TECHNICAL FIELD

The present invention relates to the field of network communication technology, and more especially, to a method and a system for transmitting multichannel data packets.

### BACKGROUND OF THE RELATED ART

In the color RBT (ring back tone) server application based on Linux operating system, massive audio files need to be transferred to the IP network. However, it needs to convert the audio files into the IP data packets as long as the audio files are transmitted through the IP network, and the data packets are transmitted via a network socket (such as the UDP socket).

In the prior art, the process of using the UDP to send the data packets comprises:

Step 1: call the creation system (call the socket function) to create a network socket.

Step 2: call the bind system to bind the network socket with the local IP address and the UDP port.

Step 3: call the sendto/sendmsg system to send the UDP data packets to the remote host.

Wherein, it needs to assign the remote IP address and the UDP port of the target host (that is, the target IP address and the target UDP port of the UDP data packets) when sending the UDP data packets.

Step 4: call the close system to close the network socket.

When using this process in the prior art, one network socket is needed for each channel of audio stream, the user process packages the audio files into a real-time transport protocol (RTP) data packet, calls the UDP data packet transmission interface to transmit the RTP data packet out.

If individual network sockets are created for multichannel audio streams with the same remote IP address (the target IP address), it only needs to use the IP address and UDP port binding interface to set the local IP address and the port when calling the data packet transmission interface at the first time, and then to assign the remote IP address and the UDP port in the data packet transmission interface, and to transmit the data packets out. Since the remote IP address of the same channel audio stream usually does not change, the routing cache mechanism implemented in the existing data packet transmission interface is only able to support caching the remote IP address of one channel audio stream, therefore, it only needs to search the routing table for one time to acquire the next hop IP address and the MAC address corresponding to the remote IP address when transmitting the packets, and the subsequent transmissions use the routing information cached in the network socket to forward the data packet.

In the case that multi-channel data packets have the same target IP address, in order to reduce the times of the process/thread switching as well as reduce the overhead due to system call, multichannel data packets share one socket to be transmitted in the prior art. If the multichannel audio streams share the same network socket, it needs to use the bind system call to set the local IP address and the UDP port before calling the data packet transmission interface at each time, and then to assign the remote IP address and the UDP port at the data packet transmission interface and to send the data packets out.

However, since the remote IP addresses of the multichannel audio streams are usually different, while the routing cache mechanism implemented in the existing data packet transmission interface is able to support caching the remote IP address of only one channel audio stream when sending the network data packets, therefore when the remote IP address changes, it needs to again look up the routing table saved in the kernel data structure corresponding to the socket to acquire the next hop IP address and the MAC address corresponding to the remote IP address, and the frequent routing table look-up brings very large system overhead.

Therefore, when the target IP addresses of the multichannel audio streams are different, it can only takes the method that creating individual network sockets for multichannel audio streams for transmission. However, creating an individual network socket for each channel audio stream will occupy large system resource for a RTB server supporting several thousand or even tens of thousand channels. The frequent multichannel process/thread switching also affect the system performance.

Moreover, at each time of sending an audio data packet, the user process needs to use the transmission system call for one time, and at each time, the system call needs to switch from the user state to the kernel state, and after the system call returns, it switches back from the kernel state to the user state. When the color RTB server is loaded heavily, it triggers massive data copy and context switch, which significantly consumes the system CPU resource and reduces the system processing capability.

To sum up, in the case that multichannel data packets have the same target IP address, the multichannel data packets share one socket to be transmitted in the prior art to reduce the times of process/thread switching and the system call overhead. When the multichannel data packets have different target IP addresses, however, an individual network socket has to be created for each channel audio stream to transmit the data packets, therefore, the system call overhead, routing look-up overhead and times of process/thread switching in this method are relatively big. When a network socket is applied to send the data packet at each time in the prior art, it is able to cache the target IP address of only one channel data packet, thus the same network socket cannot be used to send multichannel data packets with several different target IP addresses.

Therefore, the same network socket cannot be used to transmit multichannel data packets in the prior art.

### CONTENT OF THE INVENTION

The embodiment of the present invention provides a method and system for transmitting multichannel data packets so as to transmit the multichannel data packets with the same network socket, thus improving the working efficiency of multichannel data packet transmission.

The method for transmitting multichannel data packets provided in the embodiment of the present invention comprises:

creating a network socket including a routing cache array for caching the routing information of the multichannel data packets;

acquiring the routing information of said multichannel data packets and adding the routing information in said routing cache array; and

when said multichannel data packets are required to be sent, acquiring the routing information of the multichannel data packets from said routing cache array, and transmitting said multichannel data packets out according to said routing information.

A system for transmitting the multichannel data packets provided in the embodiment of the present invention comprises:

a socket creating unit, configured to create a network socket including a routing cache array for caching the routing information of the multichannel data packets;

a transmission processing unit, configured to acquiring the routing information of said multichannel data packets and add the routing information to said routing cache array; and to acquire the routing information of said multichannel data packets from said routing cache array when said multichannel data packets are required to be sent, and to send said multichannel data packets out according to the routing information.

By creating a network socket including a routing cache array caching the routing information of the multichannel data packets; acquiring the routing information of said multichannel data packets and adding the routing information to said routing cache array; when it needs to send said multichannel data packets, acquiring the routing information of said multichannel data packets from said routing cache array and sending said multichannel data packets out according to the routing information, the embodiment of the present invention is able to send multichannel data packets with one time system call, thus avoiding the complexity that it needs to call the system at every time sending a data packet, reducing the overhead of system call for transmitting the multichannel data packets, and improving the working efficiency of the multichannel data packet transmission.

### BRIEF DESCRIPTION OF DRAWINGS

FIG. 1 illustrates a flow chart of the overall method for transmitting multichannel data packets provided in an embodiment of the present invention;

FIG. 2 illustrates the flow chart of network protocol stack system call provided in an embodiment of the present invention;

FIG. 3 illustrates the data structure used by the kernel parameter of the network protocol stack system call interface provided in an embodiment of the present invention; and

FIG. 4 illustrates the structure of the system for transmitting multichannel data packets provided in an embodiment of the present invention.

### PREFERRED EMBODIMENTS OF THE PRESENT INVENTION

The embodiment of the present invention provides a method and system for transmitting multichannel data packets with high performance based on Linux network protocol stack to send the multichannel data packets with the same network socket without affecting the original Linux network protocol stack, so as to reduce the CPU consumption due to the system call, routing information look-up or process/thread switch as much as possible, and to improve the system processing capability and the working efficiency of multichannel data packet transmission.

The embodiment of the present invention takes the to-be-sent multichannel data packets being multichannel audio streams for example, of course, for other types of data packets, the technical scheme provided in the embodiment of the present invention is also applicable.

Said multichannel data packets in the present invention are a plurality of data packets with different IP addresses.

The technical scheme provided in the embodiment of the present invention will be illustrated in the following with reference to accompanying figures.

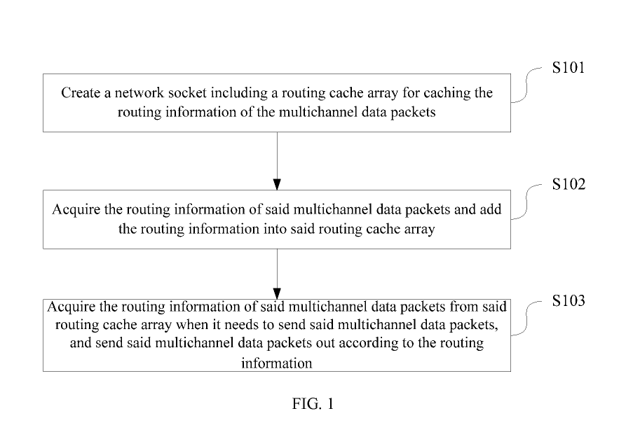

Refer to FIG. 1, the method for transmitting multichannel data packets provided in the embodiment of the present invention generally comprises the following steps of:

S101: creating a network socket including a routing cache array for caching the routing information of multichannel data packets;

S102: acquiring the routing information of the multichannel data packets and adding the routing information into the routing cache array;

S103: when said multichannel data packets are required to be sent, acquiring the routing information of the multichannel data packets from the routing cache array and sending the multichannel data packets out according to the routing information of each channel data packet.

In the embodiment of the present invention, multichannel audio streams are sent by creating only one network socket, and the mechanism for caching the routing information of multichannel audio streams into the network socket is implemented, so that the network socket does not need to repeat the routing look-up when serving the multichannel audio streams.

The embodiment of the present invention implements multichannel audio stream transmission by calling the system for only one time, and with each time of calling the system, one data packet can be transmitted for each of the multichannel audio streams, it should be noted that creating a network socket might need to send data packets to multiple users for several times, and the data packet transmission system needs to be called at each time transmitting the data packets, in the embodiment of the present invention, however, at each time calling the data packet transmission system can transmit the data packets to a plurality of users, that is, transmit multichannel data packets.

When creating the network socket, the embodiment of the present invention assigns one routing cache unit to each channel of audio stream in the kernel cache space of the network socket, and one simple implementation method is to assign a routing cache array to cache the routing information of the multichannel data packets.

When calling the data packet transmission system to send the multichannel data packets for the first time after creating the network socket, for each channel of audio stream, the embodiment of the present invention looks up the routing table to acquire the routing information of this channel of audio stream, caches the routing information of each channel of audio stream into the routing cache array, so as to implement the function of caching the routing information corresponding to the multichannel audio streams. The routing information of each channel of data packets cached in the routing cache array corresponds to the index value of this channel of data packets, and according to the index of each channel of data packets in the multichannel data packets, the routing information of this channel of data packets corresponding to this index can be acquired from the routing cache array.

When calling the data packet transmission system again to transmit multichannel data packets after calling the data packet transmission system to transmit the multichannel data packets for the first time, for each channel of audio stream, there is no need to look up the routing table to acquire the routing information of this channel of audio stream, the routing information can be directly acquired from the items in the routing cache array according to the index of each channel of audio stream to complete the routing look-up function of the data packets, so that the data packets can be rapidly sent out.

When closing the network socket after transmitting the multichannel data packets, the embodiment of the present invention also needs to release the routing cache array besides of recycling resources normally.

At the system call interface for transmitting the multichannel data packets, the embodiment of the present invention needs to input the information of multichannel audio data packets, and the information includes the load of the audio data packets and the corresponding remote IP address and the UDP port. Within the system call, for each channel of audio stream, acquire the routing information from the routing cache array according to the corresponding index, and after encapsulating the load of the audio data packets, send each channel of audio stream out according to the routing information.

In the embodiment of the present invention, the routing information acquired from the routing cache array comprises: the next hop IP address of the local port, or the next hop IP address of the local port and the MAC address.

Wherein, the next hop MAC address of the local port can be acquired according to the next hop IP address of the local port, however, in order to speed up the process, both the next hop MAC address and the next hop IP address of the local port can be cached in the routing cache array so that the next hop MAC address of the local port can be acquired directly.

Since the transmission of multichannel audio streams can be achieved with one network socket and one system call, the embodiment of the present invention can avoid repeatedly switching of a plurality of processes/threads due to serving multichannel users.

The network socket programming interface provided in the network protocol stack in the embodiment of the present invention comprises: a socket system for creating a network socket, a close system for closing the network socket, a sendmsg system for sending the multichannel data packets with high performance. Said network protocol stack is used to implement the function of caching the routing information of multichannel data packets and to send multichannel audio streams with one system call, compared with the network protocol stack in the current Linux kernel, it reduces the routing lookup and system call overhead in the processing of encapsulating and sending the audio data packets.

The embodiment of the present invention will be described in detail with combination of the accompanying figures.

The method for sending the multichannel data packets with high performance based on the Linux network protocol stack in the embodiment of the present invention uses the original Linux network protocol stack which is implemented with the kernel module mechanism, and the loading and unloading of said kernel module do not affect the original network protocol stack in the Linux kernel.

The software and hardware of said color RTB server in the embodiment of the present invention comprise the user process space, Linux kernel space and hardware device (including the network card). The Linux kernel space is between the hardware device and the user process, and a network protocol stack is configured in the network card driver in the kernel space, the network protocol stack provides the user process the network socket programming interface which mainly comprises the socket, close and sendmsg systems, wherein, the socket system is used to create the network socket, the close system is used to close the network socket and the sendmsg system is used to send the multichannel data packets with high performance.

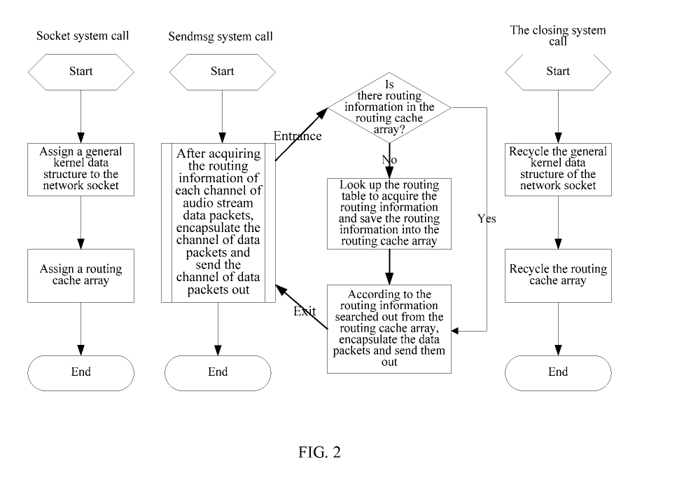

The process of the network protocol stack system call implemented in the embodiment of the present invention is as shown in FIG. 2, the hardware environment in accordance with the embodiment of the present invention needs a network card, the software environment is the Linux kernel with proper network function. In order to send the multichannel data packets with high performance, the embodiment of the present invention creates the MULTI network protocol stack based on the network socket type of AF_MULTI on the basis of the Linux kernel. The network protocol stack provides the user process an AF_MULTI network socket programming interface.

The definition and explanation of the sendmsg system implemented in the embodiment of the present invention are as follows:

Definition: ssize_t sendmsg(int socket, const struct msghdr *msg, int flags).

Function: send the multichannel audio stream data with high performance via the network socket, implement the function of caching the multichannel routing information and the function of forwarding the multichannel data packets within the system call.

The explanation of the input and output parameters:

socket: use the socket system call to create an AF_MULTI network socket.

msg->msg_name: reserved, set as NULL.

msg->msg_namelen: reserved, set as 0.

msg->msg_iov: input parameter, a pointer pointing to struct iovec. Each struct iovec comprises the cache address and length of one channel of to-be-sent audio stream data.

msg->msg_iovlen: input parameter, used to save the length of the array of struct iovec to which msg_iov points.

msg->msg_control: input and output parameter, used to save the control information of each audio stream data packet during input, the control information comprising the IP addresses and the UDP ports of the local port and the other-end port; used to return the index and the error code of the data packet which is failed to send or sent with error during output, also used to further return the number of data packets which are sent successfully and that of the data packets which are failed to send.

msg->msg_controllen: input parameter, used to save the total length of msg_control.

msg->msg_flags, reserved, set as 0.

flags: reserved, set as 0.

The description of the msg_control return value: if none of the data packets is sent successfully, the output parameter msg_control is returned as −1, and the error code is set as errno. Said error code comprises the information of the reason of the failed transmission. If all data packets are sent successfully, the msg_control is returned as 0. If some of the data packets are not sent successfully, the msg_control is returned as the number of successfully sent data packets or the number of failed sent data packets, as well as the index of the data packets that are not sent successfully and the corresponding error code.

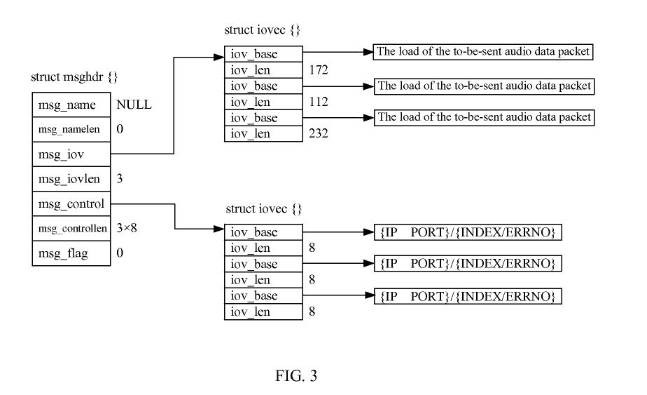

The data structure struct msghdr of the kernel parameter msg is as shown in FIG. 3, it comprises three to-be-sent audio stream data packets. The information constructing the audio stream data packets is saved in the parameter msg, and msg_iov is used to save the load information of the to-be-sent audio stream data packets, including the address and the length information of the user data cache, which is used as the load of the audio stream data packets; the msg_control is used to save the header information of the to-be-sent audio stream data packets, including the remote IP address and the UDP port number, which is used to create the header of the IP data packets.

When calling the sendmsg system, the embodiment of the present invention assigns a kernel cache structure in the kernel space for each to-be-sent audio stream data packet, and the data of the kernel cache structure comprises two parts: one part is the load of the audio stream data packet, and the load is acquired from the load information included in the msg_iov; the other part is the header information of the audio stream data packet, the header comprises the IP address, the UDP port and the MAC address information of the local port, and the remote IP address and the UDP port acquired from the msg_control, and the routing information acquired from the routing cache array, that is, the next hop IP address and the MAC address of the local port.

The system provided in the embodiment of the present invention will be introduced with reference to the accompanying figures.

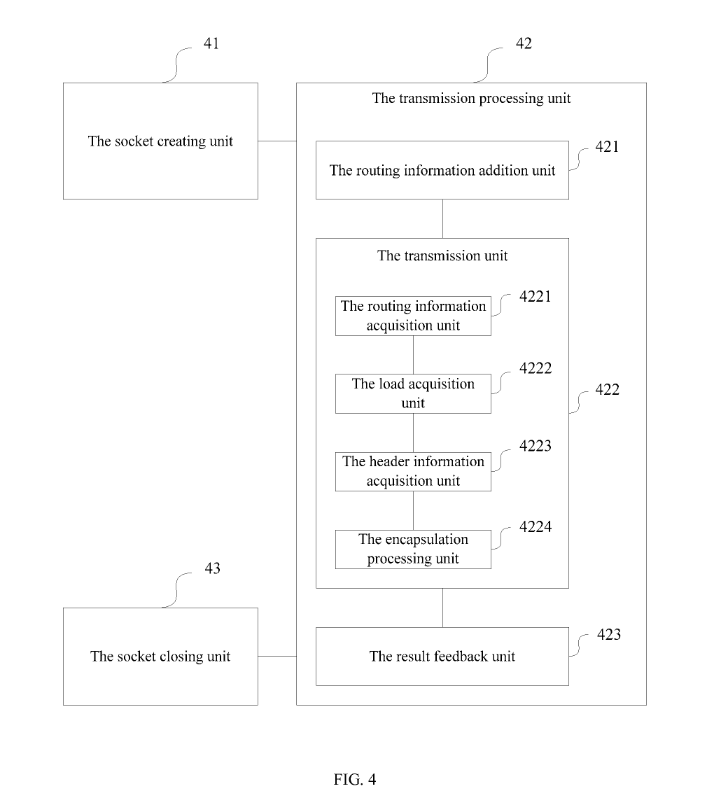

Refer to FIG. 4, the system for transmitting the multichannel data packets provided in the embodiment of the present invention comprises:

a socket creating unit 41, which is used to create a network socket including a routing cache array for caching the routing information of the multichannel data packets;

a transmission processing unit 42, which is used to acquire the routing information of the multichannel data packets and add the routing information into the routing cache array; and to acquire the routing information of the multichannel data packets from the routing cache array when it needs to send said multichannel data packets and send the multichannel data packets out according to the routing information.

Preferably, said transmission processing unit 42 comprises:

a routing information adding unit 421, which is used to acquire the routing information of the multichannel data packets and add the routing information into the routing cache array, the routing information of each channel data packet cached in the routing cache array corresponds to the index of this channel data packet;

a transmission unit 422, which is used to, when it needs to send said multichannel data packets, acquire according to the index of each channel of data packet in the multichannel data packets the routing information of this channel of data packet corresponding to the index from the routing cache array and send this channel of data packet out according to the routing information.

Preferably, said transmission unit 422 comprises:

a routing information acquisition unit 4221, which is used to acquire the routing information of one channel of data packet corresponding to the index from the routing cache array according to the index of each channel of data packet in the multichannel data packets when it needs to send said multichannel data packets;

a load acquisition unit 4222, which is used to acquire the load of multichannel data packets;

a header information acquisition unit 4223, which is used to acquire the header information of said multichannel data packets, wherein, the information comprises the local IP address, the network socket UDP interfaces, the MAC addresses, the remote IP addresses and the UDP interfaces of the multichannel data packets, as well as the routing information;

the encapsulation processing unit 4224, which is used to use the load of each channel of data packets and their header information to create the multichannel data packets, and send the multichannel data packets out according to the routing information of each channel of data packets.

For example, for each audio stream in the multichannel audio streams, use the load and header information of this audio stream to create its IP data packet and send this IP data packet out according to the routing information of this audio stream.

Preferably, said transmission processing unit 42 also comprises:

a result feedback unit 423, which is used to output the number of data packets that are sent successfully, and/or the index and error code of the data packets that are failed to send.

Preferably, said system also comprises:

a socket closing unit 43, which is used to close the network socket and release the routing cache array.

To sum up, the method and system provided in the embodiment of the present invention fully use the single channel routing look-up function in the original Linux network protocol stack to implement the function of caching the multichannel routing information. Compared with the existing Linux kernel network protocol stack, the embodiment of the present invention uses one network socket to cache the routing information of multichannel data packets, reduces the routing look-up operation in the process of forwarding the multichannel data packets. Moreover, the embodiment of the present invention uses the data structure of system call in the original Linux kernel network protocol stack, and implements the function of forwarding the multichannel data packets with one system call, thus avoids the complexity that the system call is needed for every time sending one data packet and reduces the system call overhead in the process of forwarding the multichannel data packets.

It should be noted that the above network protocol stack is implemented with software, and the implementation of the system call is also well known in the prior art, thus the description on the specific implementation process will be omitted from the embodiment of the present invention.

Of course various modifications and transformations can be made to the present invention by those having ordinary skills in the art without departing from the spirit and essence of the present invention. Thus, if these modifications and transformations made to the present invention belong to the scope of the claims of the present invention or their equivalent technology, the present invention intends to include all these kinds of modification or variations.

### INDUSTRIAL APPLICABILITY

By creating a network socket including a routing cache array caching the routing information of the multichannel data packets; acquiring the routing information of said multichannel data packets and adding routing information to said routing cache array; when it needs to send said multichannel data packets, acquiring the routing information of said multichannel data packets from said routing cache array and sending said multichannel data packets out according to the routing information, the embodiment of the present invention is able to send multichannel data packets with one time system call, thus avoiding the complexity that it needs to call the system at every time sending a data packet, reducing the overhead of system call for transmitting the multichannel data packets, and improving the working efficiency of the multichannel data packet transmission.

1. A method for transmitting multichannel data packets, comprising:
creating a network socket including a routing cache array for caching routing information of the multichannel data packets;
acquiring the routing information of said multichannel data packets and adding the routing information in said routing cache array; and
when it needs to transmit said multichannel data packets, acquiring the routing information of the multichannel data packets from said routing cache array, and transmitting said multichannel data packets out according to said routing information.

2. The method of claim 1, wherein, the step of acquiring the routing information of said multichannel data packets from said routing cache array comprises:
according to an index of each channel of data packets in said multichannel data packets, acquiring routing information corresponding to the index from said routing cache array so as to get the routing information of said multichannel data packets.

3. The method of claim 1, wherein, said step of transmitting said multichannel data packets out according to said routing information comprises:
acquiring load and header information of the multichannel data packets; and
using the load and header information of each channel of data packets to generate the multichannel data packets, and transmitting said multichannel data packets out according to the routing information of each channel of data packets.

4. The method of claim 1, wherein, after transmitting said multichannel data packets out, said method also comprises:
closing said network socket and releasing said routing cache array.

5. The method of claim 4, wherein, before closing said network socket while after transmitting said multichannel data packets out, said method also comprises:
outputting the number of the data packets that are sent successfully and/or an index and error code of the data packets that are failed to be sent.

6. A system for transmitting multichannel data packets, comprising:
a socket creating unit, configured to create a network socket including a routing cache array for caching routing information of the multichannel data packets;
a transmission processing unit, configured to acquire the routing information of said multichannel data packets and add the routing information to said routing cache array; to acquire the routing information of said multichannel data packets from said routing cache array when the multichannel data packets are required to be sent, and to send said multichannel data packets out according to the routing information.

7. The system of claim 6, wherein, said transmission processing unit comprises:
a routing information addition unit, configured to acquire the routing information of the multichannel data packets and add the routing information into the routing cache array, the routing information of each channel of data packets cached in the routing cache array corresponding to an index of this channel of data packets;
a transmission unit, configured to, when said multichannel data packets are required to be sent, acquire according to the index of each channel of data packets in the multichannel data packets the routing information of this channel of data packet corresponding to the index from the routing cache array and to send this channel of data packets out according to the routing information.

8. The system of claim 7, wherein, said transmission unit comprises:
a routing information acquisition unit, configured to acquire according to the index of each channel of data packets in the multichannel data packets the routing information of the channel of data packet corresponding to the index from the routing cache array when said multichannel data packets are required to be sent;
a load acquisition unit, configured to acquire load of the multichannel data packets;
a header information acquisition unit, configured to acquire header information of said multichannel data packets; and
an encapsulation processing unit, configured to use the load of each channel of data packets and header information thereof to create the multichannel data packets, and to send the multichannel data packets out according to the routing information of each channel of data packets.

9. The system of claim 7, wherein, said transmission processing unit also comprises:
a result feedback unit, configured to output the number of data packets that are sent successfully, and/or the index and error code of the data packets that are failed to be sent.

10. The system of claim 6, the system also comprising:
a socket closing unit, configured to close the network socket and release the routing cache array.

11. The method of claim 2, wherein, after transmitting said multichannel data packets out, said method also comprises:
closing said network socket and releasing said routing cache array.

12. The method of claim 3, wherein, after transmitting said multichannel data packets out, said method also comprises:
closing said network socket and releasing said routing cache array.

13. The system of claim 8, wherein, said transmission processing unit also comprises:
a result feedback unit, configured to output the number of data packets that are sent successfully, and/or the index and error code of the data packets that are failed to be sent.
